(19) United States
(12) Patent Application Publication
(10) Pub. No.: US 2016/0092401 A1
(43) Pub. Date: Mar. 31, 2016

(54) Document Generation Methods and Systems

(71) Applicant: Jeffrey O'Connor, Spokane, WA (US)

(72) Inventor: Jeffrey O'Connor, Spokane, WA (US)

(21) Appl. No.: 14/502,401

(22) Filed: Sep. 30, 2014

(51) Int. Cl. G06F 17/21; G06F 17/30

(52) U.S. Cl. CPC G06F 17/211; G06F 17/30675

(57) ABSTRACT

Document generation methods and systems are described. According to one aspect, A document generation method includes accessing a file comprising a transcription of dictated content, searching the dictated content, during the searching, locating an agent identifier in the dictated content which identifies one of a plurality of agents, as a result of the locating the agent identifier, generating a first document regarding the one agent which comprises the dictated content, during the searching, locating one of a plurality of structure keywords in the dictated content, formatting the first document in accordance with the one structure keyword, during the searching, locating one of a plurality of content keywords in the dictated content, adding new textual content to the first document in accordance with the one content keyword, locating one of a plurality of action keywords in the first document, and generating a second document regarding the one agent in accordance with the one action keyword.

### TECHNICAL FIELD

This disclosure relates to document generation methods and systems.

### BACKGROUND OF THE DISCLOSURE

Document generation is used in numerous different businesses for different purposes. For example, in the healthcare industry, documents are generated and maintained in charts to provide medical histories for the patients being treated. A treating physician may have numerous appointments with different patients during a day. Following completion of the patient visits, a physician typically generates documents for placement in the charts of the patients, however, numerous other documents may also need to be generated as a result of the patient encounters. Other illustrative examples of documents generated in the healthcare industry include referral letters to other medical specialists, letters to patients, laboratory orders, and communications to medical agencies and insurance companies.

At least some aspects of the disclosure are directed to document generation methods and systems to assist users with the generation of documents.

### BRIEF DESCRIPTION OF THE DRAWINGS

Example embodiments of the disclosure are described below with reference to the following accompanying drawings.

FIG. 1 is a functional block diagram of a document generation system according to one embodiment.

FIG. 2 is a functional block diagram of a computing system according to one embodiment.

FIGS. 3A-3C illustrate text of a standard office note resulting from a text expansion process according to one embodiment.

FIG. 3D illustrates an example of a default list included in a generated document according to one embodiment.

FIG. 4 illustrates text of a referral letter resulting from a text expansion process according to one embodiment.

FIG. 5 illustrates text of the referral letter of FIG. 4 being reproduced as a progress note according to one embodiment.

FIGS. 6A-6D illustrate a standard office note document resulting from processing of the text of FIGS. 3A-3C according to one embodiment.

FIG. 7 illustrates a referral letter document resulting from resulting from processing of the text of FIG. 4 according to one embodiment.

FIG. 8 illustrates a standard office note document generated from the text of the referral letter of Fig. according to one embodiment.

FIG. 9 illustrates a patient instruction document resulting from processing of the text of FIGS. 3A-3C according to one embodiment.

### DETAILED DESCRIPTION OF THE DISCLOSURE

This disclosure is submitted in furtherance of the constitutional purposes of the U.S. Patent Laws “to promote the progress of science and useful arts” (Article 1, Section 8).

Example document generation methods and systems are described below in illustrative embodiments for use within the healthcare industry. However, the described methods and systems may be used in other user applications, businesses or industries for other purposes in other implementations.

At least some embodiments of the present disclosure are directed towards apparatus and methods of processing text, for example resulting from dictated and/or keyed input of an individual, to generate documents therefrom as well as manage the generated documents. The processing of the text may be tailored to a specific application or purpose, such as for use by medical personnel to generate documents for various purposes related to the medical field including use of documents in the treatment of patients. The apparatus and methods may be adapted for use in other applications, such as legal, educational, and corporate, where dictation is commonly used to generate documents.

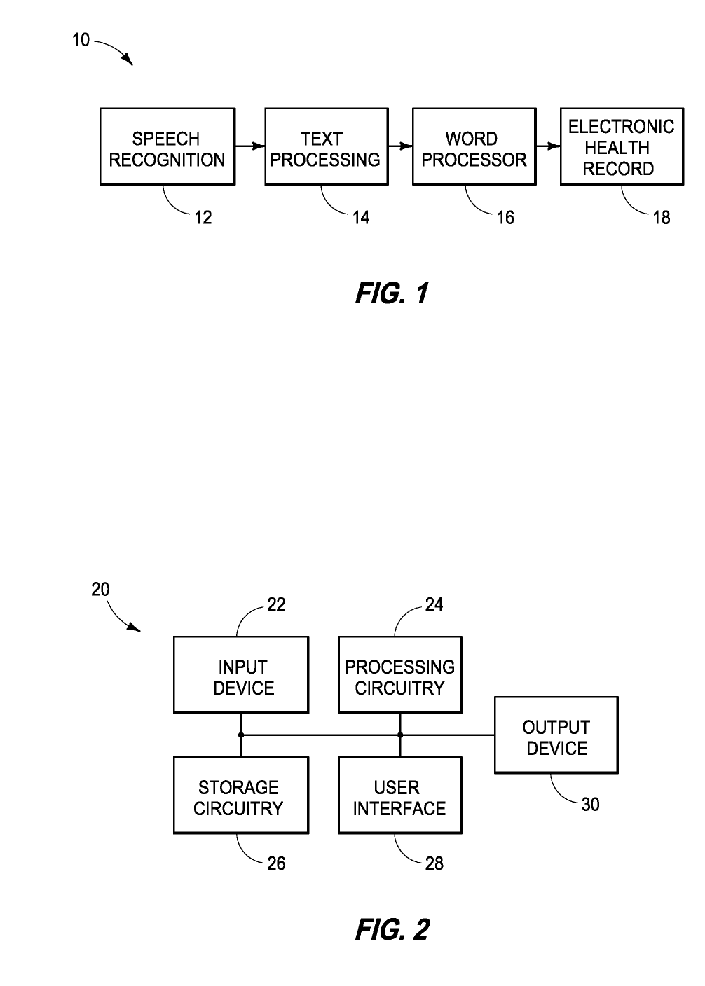

Referring to FIG. 1, a high-level functional block diagram of a system 10 including a plurality of software applications which may be utilized to process text and generate and manage documents therefrom is shown according to one embodiment. The example software applications are illustrative in the disclosed embodiments and other software applications may be used in other implementations or embodiments. Example documents which are generated include paper and electronic documents.

The example embodiment of the system 10 of FIG. 1 includes a speech recognition application 12, a text processing application 14, a word processor application 16, and an electronic health record application 18. As mentioned above, the disclosed systems and methods may be used by medical personnel to generate documents with respect to the treatment of patients (or other subjects, such as an agents or clients in other applications). In more specific examples, the disclosed systems and methods may be used by medical personnel to generate documents (e.g., forms for physician use) prior to patient visits to be used during the visits as well as to generate post visit documents, including standard office notes, progress notes, referral letters, and letters to the patient.

The speech recognition application 12 is configured to implement transcription operations to convert output from a microphone (e.g., dictation) into textual content in one embodiment. One speech recognition application 12 which may be used is Dragon NaturallySpeaking available from Nuance Communications. The speech recognition application 12 generates a file which comprises a transcription of the dictation in one embodiment.

Text processing application 14 accesses the generated file of the transcribed textual content and performs additional processing upon the textual content as described below. For example, the text processing application 14 may generate documents having appropriate structure and formatting in accordance with the dictation, provide text expansion operations, insert codes for use by subsequent applications (such as the electronic health record application 18) and perform additional operations described below.

In one embodiment, the text processing application 14 searches the textual content for predefined content which causes different actions to be performed in accordance with specified content. For example, the textual content may be searched for patient identifiers, codes and keywords (e.g., structure keywords, content keywords, action keywords, and protected keywords). In one embodiment, different actions described below are performed when identifiers and keywords are located in the textual content. One text processing application 14 which may be used is TextPipe available from DataMystic.

One word processor application 16 which may be used is Word available from Microsoft Corp. The word processor application 16 is configured to format the generated documents for presentation in final form including paper documents and electronic documents and which may include letter formats, note formats, etc. The word processor application 16 may be used by the user to edit textual content within the file of transcribed dictation as well as generated documents in intermediate and final forms.

One electronic health record application 18 which be used is Practice Partner available from the McKesson Corporation. The electronic health record application manages records of patients being treated by the medical personnel. Application 18 manages a database of medical information about the patients whose records are stored in the program, and each patient may have a variety of data elements stored: office/progress notes, lab and x-ray reports, correspondence, medications, etc.

Health record application 18 may generate final documents which are retained within the electronic health records of patients and perhaps sent to other entities (e.g., patient, laboratory, physician being referred to, etc.). Textual content of correspondence within documents sent to patients, physicians or other parties may be copied, stored and managed by electronic health record application 18 in one embodiment.

Practice Partner uses dot codes to identify, catalog, distribute and retrieve data elements stored for each patient. For instance, using properly embedded dot codes, a letter to a consultant can not only include the standard text of the correspondence but a list of all medical problems, lab results, medications and allergies stored on that patient. In one embodiment, the medical problems, lab results, medications and allergies are automatically inserted into generated documents via text expansion described below by the addition of properly embedded dot codes as default text into documents being generated as described in illustrative example embodiments below. Furthermore, embedded dot codes may cause textual content of documents to be copied and stored into correct sections of a patient's chart in the electronic health record application 18 in one embodiment.

Referring to FIG. 2, components of one embodiment of a computing system 20 which may be used to process text and generate and manage documents are shown. In the illustrated example embodiment, the components include an input device 22, processing circuitry 24, storage circuitry 26, a user interface 28, and an output device 30. Other embodiments are possible including more, less and/or alternative components.

Input device 22 is configured to generate electrical signals as a result of variations in air pressure, such as a result of a human speaking. In addition, the input device 22 may also perform digital sampling of the electrical signals to generate digital samples corresponding to the human voice. The input device 22 includes a microphone and associated circuitry in one embodiment.

In one embodiment, processing circuitry 24 is arranged to process data, control data access and storage, issue commands, execute the applications of FIG. 1 and control other desired operations. Processing circuitry 24 may comprise circuitry configured to implement programming provided by appropriate computer-readable storage media in at least one embodiment. For example, the processing circuitry 24 may be implemented as one or more processor(s) and/or other structure configured to execute executable instructions including, for example, software and/or firmware instructions. Other example embodiments of processing circuitry 24 include hardware logic, PGA, FPGA, ASIC, state machines, and/or other structures alone or in combination with one or more processor(s). These examples of processing circuitry 24 are for illustration and other configurations are possible.

Storage circuitry 26 is configured to store programming such as executable code or instructions of the applications of FIG. 1 (e.g., software and/or firmware), electronic data, databases, or other digital information and may include computer-readable storage media. In more specific examples, the storage circuitry 26 stores files generated by input device 22 as well as generated documents. In addition, in one embodiment, the storage circuitry 26 may also store data regarding patients in a database which may be accessed and included in one or more files or documents generated by systems and methods.

At least some embodiments or aspects described herein may be implemented using programming stored within one or more computer-readable storage medium of storage circuitry 26 and configured to control appropriate processing circuitry 24. The computer-readable storage medium may be embodied in one or more articles of manufacture which can contain, store, or maintain programming, data and/or digital information for use by or in connection with an instruction execution system including processing circuitry 24 in one embodiment. For example, computer-readable storage media may be non-transitory and include any one of physical media such as electronic, magnetic, optical, electromagnetic, infrared or semiconductor media. Some more specific examples of computer-readable storage media include, but are not limited to, a portable magnetic computer diskette, such as a floppy diskette, a zip disk, a hard drive, random access memory, read only memory, flash memory, cache memory, and/or other configurations capable of storing programming, data, or other digital information.

User interface 28 is configured to interact with a user including conveying data to a user (e.g., displaying visual images including textual content and documents for observation by the user) as well as receiving inputs from the user, for example via a keyboard, mouse, or other input device.

Output device 30 is configured to print hard copies of documents for mailing, filing and/or other purposes. In addition, output device 30 may also include communications circuitry configured to implement communications with external devices and networks, such as the Internet.

Examples of processing of textual content according to one embodiment are described below. Initially, a file comprising textual content is accessed. The file may be generated in any appropriate manner by speech recognition application 12 and/or as a result of keyboard inputs in an illustrative example. In one embodiment, a user may dictate content which is transcribed by the speech recognition application, and thereafter the user may access and review the dictated content and use the keyboard to correct any transcription errors to prepare the textual content for further processing. An example of a file including transcribed textual content resulting from dictation by medical personnel following a patient visit is shown below in Table A.

TABLE A
100,002 NIDDM: Hypercholesterolemia: Hypertension: Anemia: B12
deficiency #2 NIDDM could be better. Hypercholesterolemia
established hypertension established anemia and needs lab. B12
deficiency needs lab plan lab results and like you to increase her
Lantus to 40 units at night. Stop irregular insulin at night. I like to see
her back in 4 months we will check his cholesterol and A1c subjective
overall feels good. Blood sugar went up but really didn't do anything
about it. Trying to watch her diet but gained 2 pounds. She will plan
to increase exercise. Cholesterol tolerates blood pressure tolerates
review of systems General: Negative head and neck: Negative skin:
Negative breathing: Negative heart: Negative stomach: some cramps
and diarrhea bladder: Occasional leakage blood vessels: Negative
skeleton: Joint pain brain: Negative hormones: Negative blood:
negative emotions: Upset in dealing with her husband breasts:
Negative objective normal pinna normal nose mouth reveals dry
mucous membranes but otherwise negative. Normal neck normal
chest heart reveals some irregularity. Normal abdomen
100,002 diabetes #8 Dr. Smith Thank you very much for this for seeing
this woman. She has had type 2 diabetes for quite a few years.
However I can't get her to follow her diet or maintain her medications.
Your evaluation would be greatly appreciated. Make a progress note

The generated file includes reduced text, appropriate identifiers, keywords and syntax as created by the user and which is accessed by the text processing application and processed according to one or more examples described below.

In this example, the user has dictated the initiation of each document using an identifier of a single agent or patient (e.g., a medical patient's ID number (nnn,nnn)). The user intends for two documents to be produced where the first is a standard office note and the second is a referral letter to another physician—both with respect to the same patient.

The text processing application accesses the file and searches the textual content for identifiers, keywords, and codes. The detection of an identifier causes the termination of the previous document, initiates generation of a new document and accesses information necessary to retrieve appropriate data for the subject of the new note.

The patient identifier may identify the subject patient being treated and may be used to access information regarding the subject patient from a database. For example, the text processing application may access the information for the identified patient from a database of patient information and generate default headers and sections for each document including data for the identified patient.

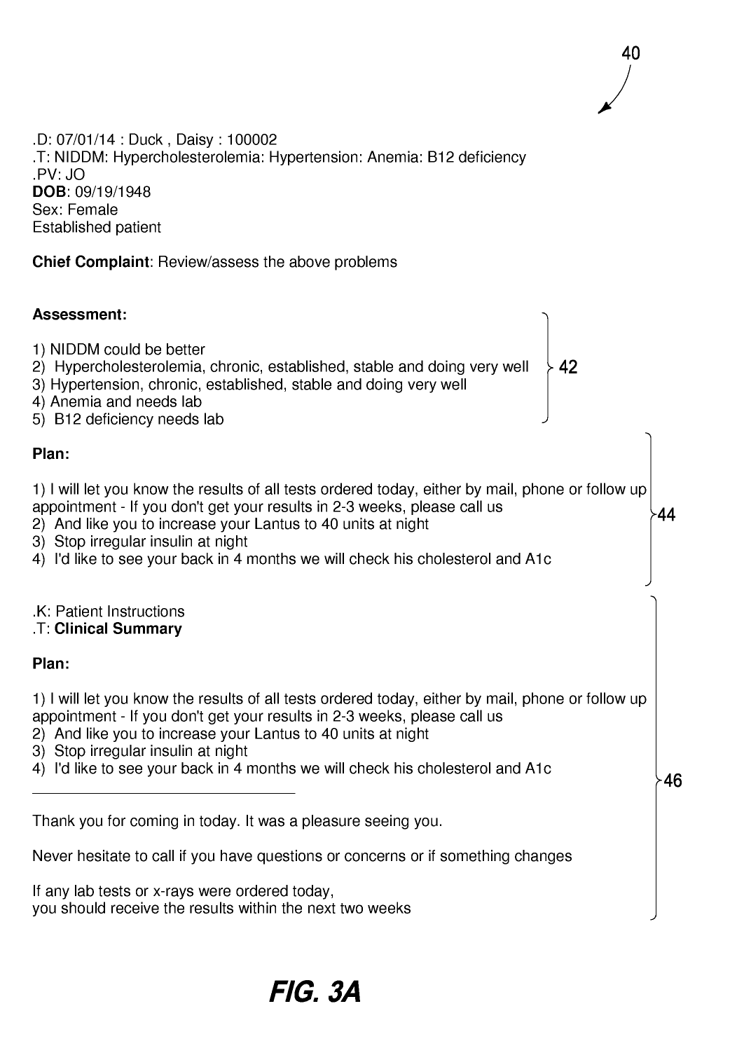

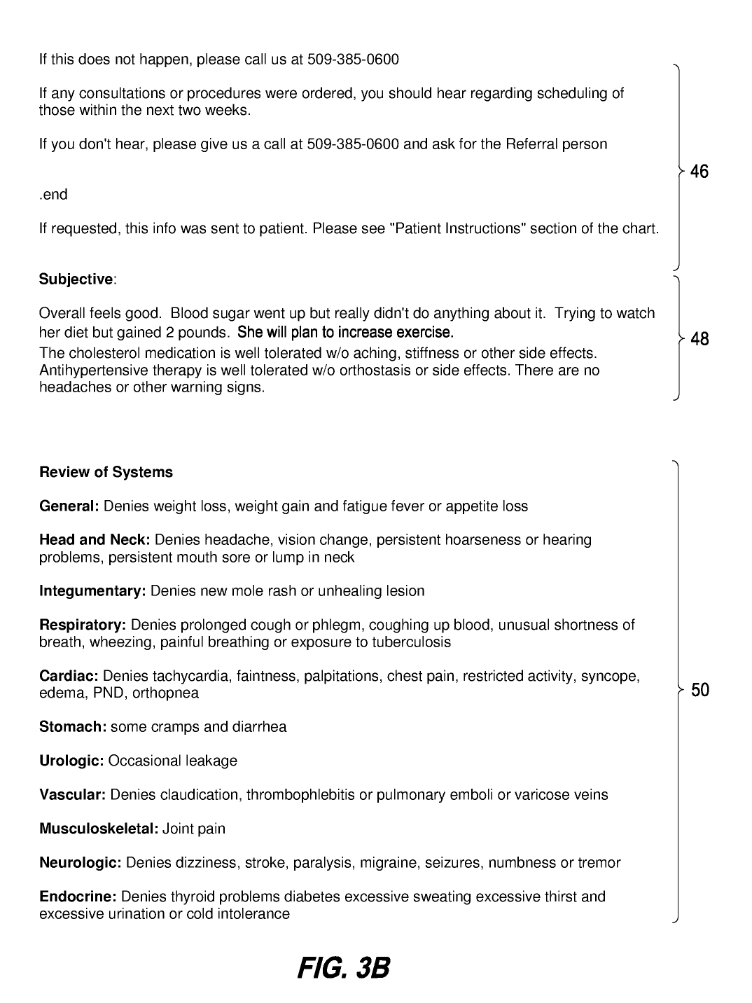

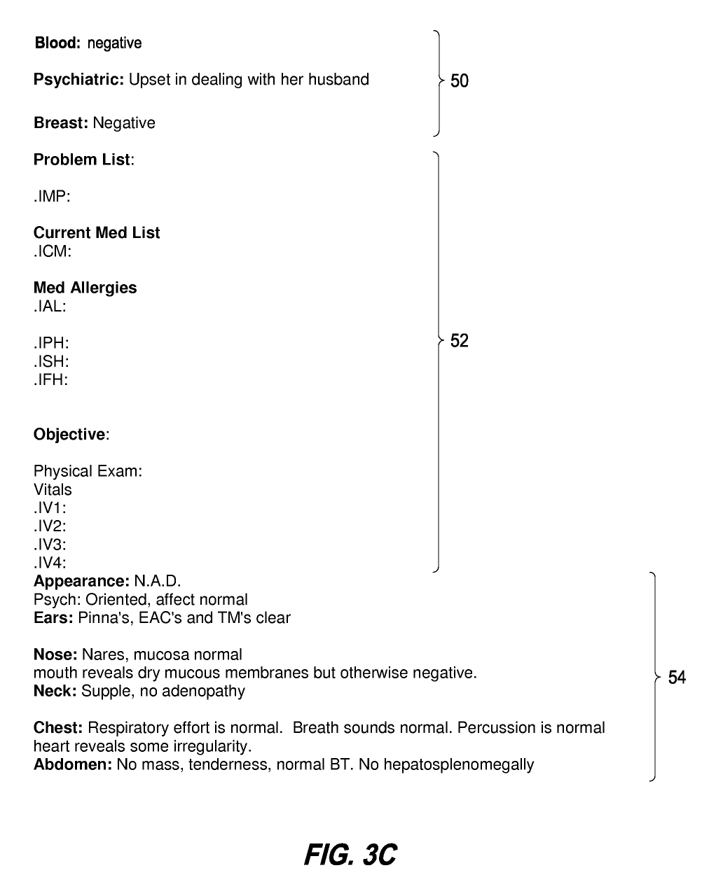

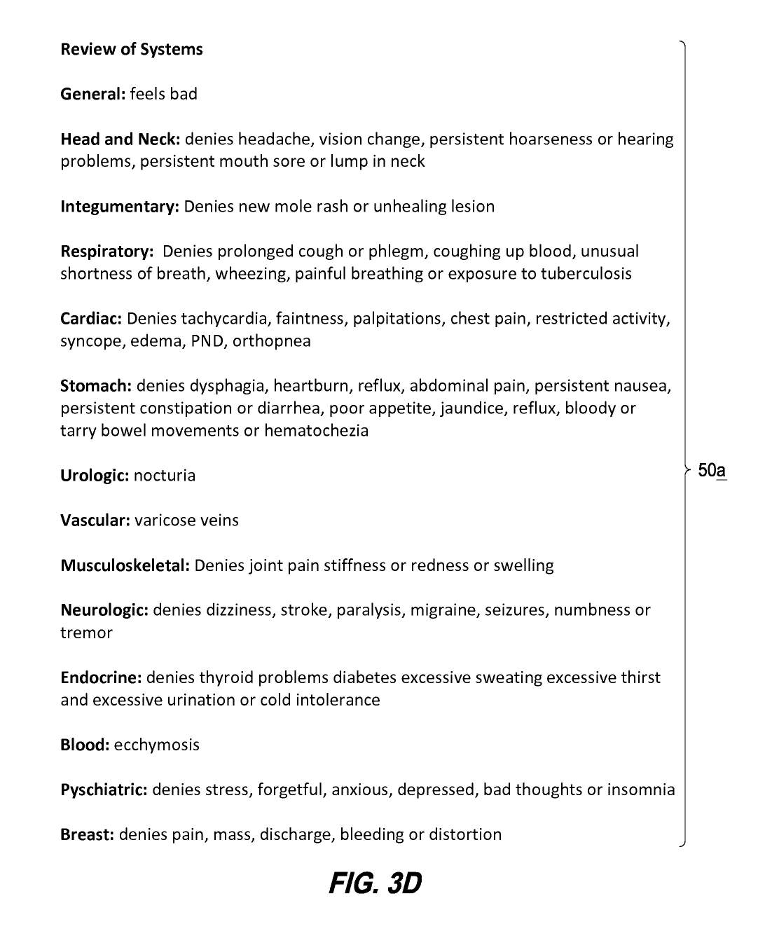

Referring to FIGS. 3A-3C, results of text expansion of the initial transcribed textual content are shown. In particular, an example document above in the form of a standard office note 40 resulting from processing of the textual content following the first patient identifier of Table A by the text processing application is shown. The structure and textual content of the created document not present in the dictation above is automatically created and inserted into the document of FIGS. 3A and 3B by the text processing application (i.e., without additional input from the user which specifies the structure or added textual content) in one embodiment described further below.

In this example, the text processing application replaces the patient identifier with a data string containing the patient name, date of dictation and patient ID number. In this instance, the data source is a comma delimited text file in a spreadsheet application, such as Excel, and the identifier is replaced with a document header of the form: “.D: 07/01/14: Duck, Daisy: 100002” where “.D” is a code for use by subsequent applications (e.g., electronic health record application 18), and which is followed by the date of processing, the name of the patient (last, first) and the identifier of the patient.

The text processing application thereafter searches for the presence of a keyword within a range of words following an identifier (e.g., within six words following the identifier in one example). Location of different keywords in the textual content during searching of the textual content may be used to cause different operations or actions to be performed with respect to generation and/or management of documents.

For example, structure keywords are used to define the type of document to be created (e.g., standard office note, referral letter, lab results letter, etc.) and to format the document in accordance with the type of structure keyword located (formatting which defines the default appearance, layout and sections to be included in the specified type of document). The structure keywords control the structure and of the documents being generated and format the textual content of the documents to facilitate review of the results of the processing.

Other keywords described below may also be present in the textual content including content keywords, action keywords and protected keywords. Different rules may be defined for the generation of the different types of document. Once a document type is identified by a keyword, the appropriate rules for the specified type of document to be generated may be accessed. The rules may define which words are keywords for the type of form to be generated as well as the structure, formatting and default textual content of the document itself.

The presence of content keywords cause the addition of new textual content to the document being generated (i.e., text expansion) and in accordance with the specific content keyword which is located. The new textual content may include new keywords which cause different actions to be performed in subsequent reiterative processing operations. In one embodiment, the presence of a keyword in the new textual content may cause yet additional new textual content to be added which may also include additional keywords. Added new keywords may cause other operations to be performed, such as generating another document or accessing content from an external data source, such as a database of the electronic health record application.

This example embodiment performs reiterative text expansion where new content may be added to the document in a number of processing steps and which may include keywords which cause yet additional textual content to be added. The text expansion process may be repeated numerous times until all text expansion is completed (e.g., no new keywords are present).

The presence of action keywords may cause different actions to be performed. In one example, locating one action keyword may revise a structure of a document, for example, causing an entire section to be added to the document. In another example, locating another action keyword may cause an entire new document to be generated in accordance with the specific action keyword which was located during the searching. For example, the keyword may specify one of a plurality of different types of new documents to be generated in addition to the initial generated document (e.g., a referral letter is generated once a keyword specifying generation of a referral letter is located in the textual content). The actions are illustrative and other actions may be performed in other examples.

Some examples of protected keywords are described below to accommodate terms which may be often used in dictation but also have other meanings specific to subject matter of the dictated textual content (e.g., medical treatment of patients). In addition, protected keywords may be used to allow modification of some textual content but not other textual content with respect to the final generated document.

The keywords may be textual or numeric and specify the development of appropriate types of document. A keyword may include one or more words in some examples. Furthermore, some keywords may individually function as more than one of the structure keywords, content keywords, action keywords and protected keywords (e.g., a single keyword may define structure of a document and cause new text to be added by text expansion).

In the described example of Table A, the textual content “#2” following the patient identifier is a structure and action keyword which initiates the generation of a standard office note with the corresponding structure shown in FIGS. 3A-3C. The textual content which precedes the keyword (i.e., “NIDDM: Hypercholesterolemia: Hypertension: Anemia: B12 deficiency”) populates the title line of the document with what was reviewed at the appointment following an inserted “.T” code for use by the electronic health record application to indicate the topic of the document.

As shown, the defined structure for the document also includes a “.PV” code followed by the initials of the person generating the document (e.g., medical provider).

As mentioned above, computing system 20 is configured to perform reiterative text processing and expansion where new or additional textual content is added to previously existing textual content of a document in a plurality of different steps and at least one or more of the steps of adding new test results from the addition of new text in a prior processing step.

As described above in one example embodiment, the action keyword #8 causes the generation of a referral letter document. In one example, a default section of a referral letter is automatically generated resulting from the presence of the keyword during a text processing step. The added default section may include one or more fields which cause the addition of new additional text during subsequent processing steps. For example, fields may be added in the default section with respect to date of birth (DOB) and sex of a patient. After the addition of the fields, the fields are recognized during subsequent processing steps and cause the insertion of additional text for the patient (e.g., from the patient database). For example, the DOB and sex fields may cause the date of birth and sex of the subject patient to be retrieved from a database and added as new text content. The data already established for the patient may also be retrieved from a database of the electronic health record application in the described example. The text processing application also automatically inserts the line “Chief Complaint: Review/assess the above problems” as default text for the illustrated document illustrating one example of text expansion of the initial dictated content.

The text processing application thereafter processes the textual content “NIDDM could be better. Hypercholesterolemia established hypertension established anemia and needs lab. B12 deficiency needs lab” in the following example. The text processing application automatically generates the assessment section 42 as a default portion of the document corresponding to the assessment of the patient's problems and inserts the textual content following the “#2” keyword into this section.

The textual content is provided into respective lines by the use of periods or keywords. For example, the first and fourth lines of this section are ceased by the use of respective periods in the textual content. However, the second and third lines are ceased by the content keyword “established.” More specifically, the identification of this content keyword in the dictated content causes the textual content immediately prior to the content keyword to be expanded into the textual content shown in the second and third lines of the assessment section.

The searching operations next uncover the textual content “plan” which is a protected keyword. In particular, during the creation of a given document (e.g., standard office note), the rules may define that the first occurrence of “plan” during the generation of a standard office note by a protected keyword which controls the generation of a “Plan:” section in the standard office note (i.e., inclusion of a plan section in this type of note is common to the medical industry). The “Plan:” section may include a portion of the content which was dictated by the user. However, the user may wish for subsequent text content within the document to include the word “plan” without generation of another “Plan:” section in the same document. In one embodiment, the word “plan” is protected by allowing the user to still dictate subsequent occurrences of the word “plan” without causing the generation of multiple “Plan:” sections in the same document.

In one embodiment, the rules for generating a standard office note define that identification of the first occurrence of the protected keyword “plan” causes the word to be converted to a non-sensical word, such as “xerxes,” which is also an action keyword which subsequently causes the generation of the plan section 44 of the document during a subsequent reiterative text expansion operation. Subsequent occurrences of the textual content “plan” are not converted to another keyword but remain as textual content “plan” to be inserted into the text of the document. For example, in the subjective section 48 of the document described below, “plan” is merely inserted in the subjective section as dictated content without causing generation of another plan section.

Following the conversion of “plan” to the action keyword “xerxes,” the textual content of the document is searched again in a subsequent reiterative processing step and the action keyword “xerxes” causes the action of generation of the plan section 44. The textual content following the action keyword is inserted as content of the plan section 44. “Lab results” in the plan content is a content keyword which is automatically converted and expanded to the textual content of the first line in the plan section 44. The other lines of textual content in the plan section 44 are defined by periods.

Accordingly, as demonstrated by the example above, use of protected keywords allows dictation of words which cause actions to be performed with respect to a given specialty (e.g., medicine) while also allowing the term to be used in common dictation. Placement of the word with the dictated content may be evaluated to determine if action is appropriate. The location of the first occurrence of the protected keyword causes the action to be performed and subsequent occurrences of the protected keyword are not changed and become content of the final generated document in one embodiment. Accordingly, an action may be performed as a result of location of a first occurrence of a given keyword and not performed as a result of location of subsequent occurrences of the given keyword within the textual content of the document (e.g., which may be within the original transcription of the dictated content or added by text expansion).

Other examples of protected keywords may be appropriate for a given application of use or specificity. For example, it may be useful to define additional protected keywords which would cause unintended operations to occur if they were not defined. For example, in medical use, a user may often dictate the word “doctor,” such as in a referral letter. However, the speech recognition application may be programmed to automatically convert “doctor” to “Dr.” Nonetheless, “Dr.” may also be a field which causes the text processing application to insert the address of a subject patient. Accordingly, in one embodiment described below, “Dr.” may be defined as a protected keyword.

More specifically, in some implementations, the dictation of the user does not include any reference to an address of the patient since insertion of patient data may be automatically generated by the presence of fields in default text of the document being generated (e.g., the default text of some types of documents include a field which automatically causes the insertion of the patient's address into the documents during processing by the electronic health record application).

In one embodiment, the text processing application initially changes the “Dr.” of “Dr. Smith” present within the transcription of the dictated content into a non-sensical word in the application of use, such as “doctorzhivago.” Thereafter, in a subsequent reiterative text processing operation, “Dr.” fields may be inserted by default into the textual content of the document to cause subsequent insertion of address information for the patient at appropriate locations of the textual content corresponding to locations of the “Dr.” fields during subsequent text processing operations. Following the insertion of the address information, all instances of the non-sensical word “cat” may be converted back to “Dr.” during a subsequent text processing operation for inclusion in the final document (e.g., as “Dr. Smith”) and illustrating another example of word protection.

Accordingly, in some embodiments, a protected keyword is converted or changed to a different word, such as a nonsensical word, and then converted or changed again back to the protected keyword and/or other content for inclusion in the generated final document.

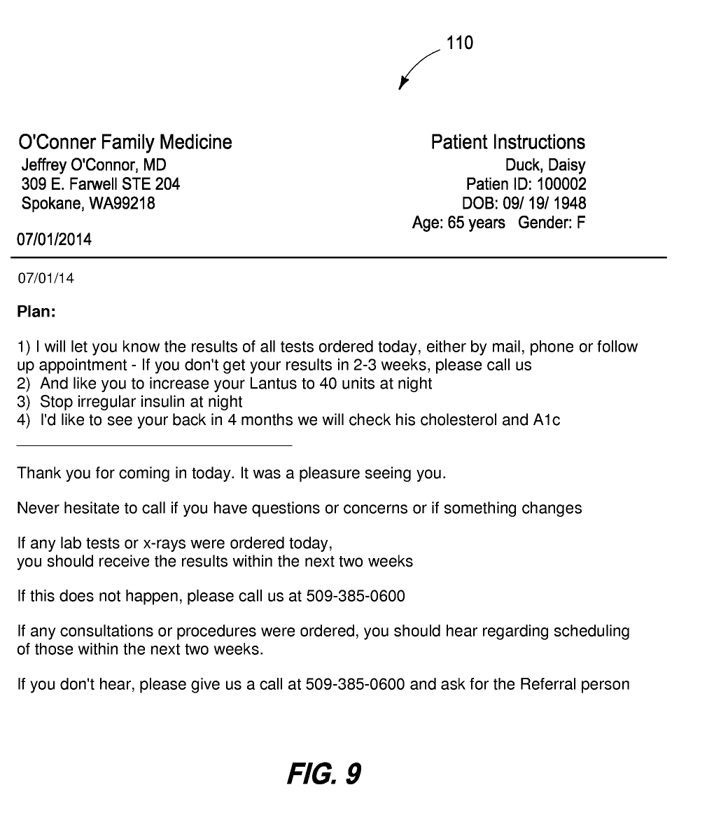

Referring again to the transcription of the dictated content recited above in Table A, the “#2” action keyword also causes the generation of the default section 46 which includes a .K code which defines which chart section of the patient's electronic medical record the subsequent textual content of the default section 46 is inserted which includes another copy of the plan section 44. In this example, the inserted default .K code is “Patient Instructions” which causes the textual content of the default section 46 to be inserted into the patient instructions portion of the patient's electronic health record. In addition, the .K code causes an action in the form of automatic generation of the patient instructions document 110 described below with respect to FIG. 9. The .T code is the topic of the note and the default text in this example is “Clinical Summary.”

The searching of the content of Table A next encounters the structure keyword “subjective” which causes the generation of the subjection section 48 and which includes the dictated content following the keyword. The content keywords “cholesterol tolerates” and “blood pressure tolerates” causes the automatic generation of the textual content regarding cholesterol and antihypertension therapy shown in subjective section 48 of the document.

Thereafter, the structure keyword “review of systems” is encountered which causes the generation of the review of systems section 50 of the document. This section includes conditions of the patient for various anatomical parts of the body resulting from the patient encounter. The lines of the textual content of this section identifies the part of the anatomy and thereafter includes status information. The anatomical parts may also be identified by words which are easier to dictate and which are changed to the textual content shown in the example note 40 (e.g., the rules change dictated content “skin” to “integumentary”). In addition, content keywords may be used to describe the status of the anatomical parts and which are converted to the textual content of the example document 40 (e.g., “negative” following skin is expanded to “denies new mole rash or unhealing lesion”).

The “objective” action keyword in the transcribed content of Table A generates the textual content of the default section 52. The textual content of the default section 52 includes a plurality of codes which control subsequent processing operations within the electronic health record application 18. For example, some of codes may cause the insertion of data from a chart for the patient in the electronic health record application 18. In the illustrated example, the codes cause the following actions to be performed:

.IMP: insert the patient's medical problems from the patient's chart into the document
.ICM: insert the patient's medications from the patient's chart into the document
.IAL: insert the patient's medication allergies from the patient's chart into the document
.IPH: insert the patient's past history from the patient's chart into the document
.ISH: insert the patient's social history from the patient's chart into the document
.IFH: insert the patient's family history from the patient's chart into the document

The action keyword “objective” also causes the generation of the default section 54 which includes default codes .IV1-.IV4 which causes the insertion of the patient's vitals from the patient's chart into the document. The subsequent content of Table A includes the content keywords “normal” associated with different parts of the body which cause the generation of the standard textual content shown in section 54. In addition, other words may also be dictated which are not content keywords and may be directly inserted into the appropriate line of the section 54 (e.g., “mouth reveals dry mucous membranes but otherwise negative” and “heart reveals some irregularity” are inserted into appropriate lines of the section 54).

Referring to FIG. 3D, an alternative example embodiment for generating the review of systems section 50 is shown. Some correspondence to be generated may include a portion of text which includes a standard or default list of a plurality of default items, such as the various systems of the human body reviewed during a patient encounter and which are included in the review of systems section 50.

In the example of FIGS. 3B-3C, the user dictates each of the systems individually and any conditions associated with the respective systems. If a system has no issues during the patient encounter, the physician may dictate “negative” which is subsequently automatically translated into the appropriate content for the respective system shown in FIGS. 3B and 3C as discussed above. Alternatively, if a patient is experiencing an issue with a system, the issue or condition may be dictated by the physician and the dictated issue or condition is included in the generated review of systems section 50 and associated with the respective system.

In the example of FIG. 3D, the dictated keyword “review of systems” causes the generation of a default list of a plurality of default items (e.g., list of systems of the human body in one example) shown as a review of system section 50a. In the described example, each item or system in the list is automatically associated with default information for the respective item unless the physician dictates content for the item (e.g., abnormal or not standard content for the item).

In one example, the default information for the systems in the list may indicate that any conditions or issues with the systems are negative (i.e., indicating that the patient is currently not experiencing any issues with the respective systems). By further example, negative default information for the system “Integumentary” is “denies new mole rash or unhealing lesion.” This default information is associated with the respective system unless the physician dictates a condition or issue for the respective system in the dictated content. For example, for the system “Musculoskeletal” the user identified the respective system and thereafter dictated “joint pain” which resulted in the default negative information of the system being replaced with the dictated content to indicate the condition or issue with the system during the encounter. This saves the user time in not having to dictate each of the systems which are negative or without any conditions or issues (e.g., “normal”) as determined during the patient visit while permitting the user to dictate existing conditions for one or more of the systems as indicated by the patient during the encounter (e.g., which are “not normal”) in this illustrative example.

Accordingly, in one embodiment, added content to a document can include a default list of a plurality of default items and default information associated with one or more of the default items (e.g., negative conditions for the respective default items) and dictated content associated with others of the default items for conditions which are other than negative.

As described above in one embodiment, default information or content is associated with a given default item as a result of the dictated content not including information or content regarding the default item and dictated content is associated with the another default item as a result of the dictated content including content regarding the another default item in this example embodiment. In this example, the user dictates abnormal content (different than the standard) which is associated with the appropriate item in the default list of default items along with default conditions for the other items which are not included in the dictation or original input file.

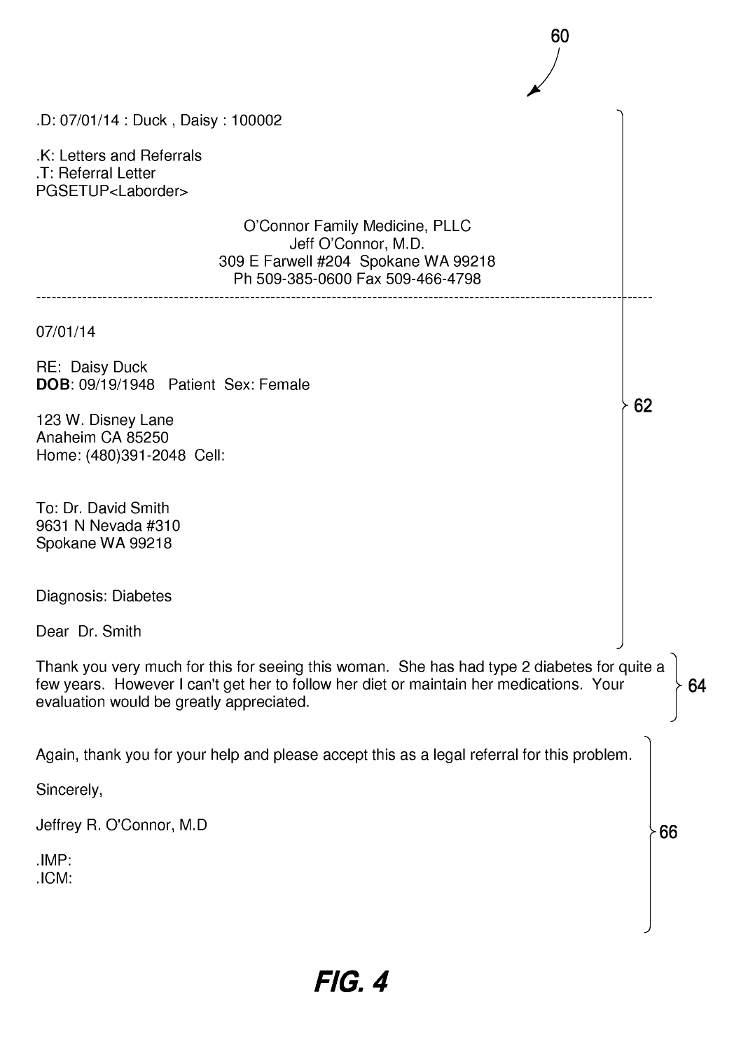

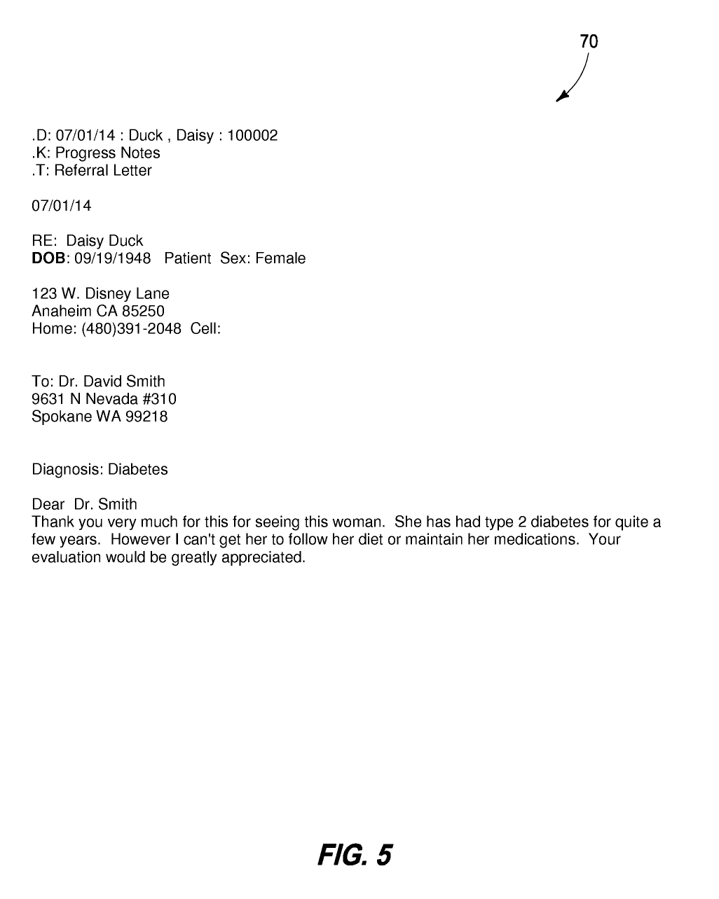

Referring again to Table A, the next content includes another patient identifier for the patient which terminates prior document 40 and initiates a new document. The text processing application replaces the identifier with a header containing the patient name, date of dictation and patient ID number. The action keyword “#8” determines the type of document to be created—a referral letter 60 in this example which is described with respect to FIG. 4 which includes additional results of text expansion and processing of the transcribed textual content of Table A as described below.

The text processing application 14 automatically generates a default section 62 of the referral letter 60. “Diabetes” prior to the #8 action keyword specifies the medical issue to be reviewed. “Dr. Smith” within the transcribed textual content following the #8 keyword indicates the recipient of the letter. Section 64 includes transcribed textual content from Table A within the body of the letter 60. The text processing application 14 automatically generates default section 66 following the body of the letter 60.

The action keyword “make a progress note” in the transcribed textual content of Table A causes the generation of a new document as a copy of the letter 60 to be placed in the progress note section of the chart of the patient in the electronic health record application 18.

Referring to FIG. 5, an example document in the form of a progress note 70 is generated as a result of the processing of the action keyword “make a progress note.” The letter 60 is automatically reproduced and reformatted into the progress note 70 and inserted into the progress note section of the chart of the patient in the electronic health record application 18.

Examples of actual output from the text processing and document generation are discussed below according to one embodiment. In one embodiment, electronic health record application 18 generates the actual output where the codes and fields have been replaced with corresponding text or data for the subject patient (e.g., lab results, medications, allergies, hospitalizations, address, sex, etc.) from databases of the electronic health record application 18.

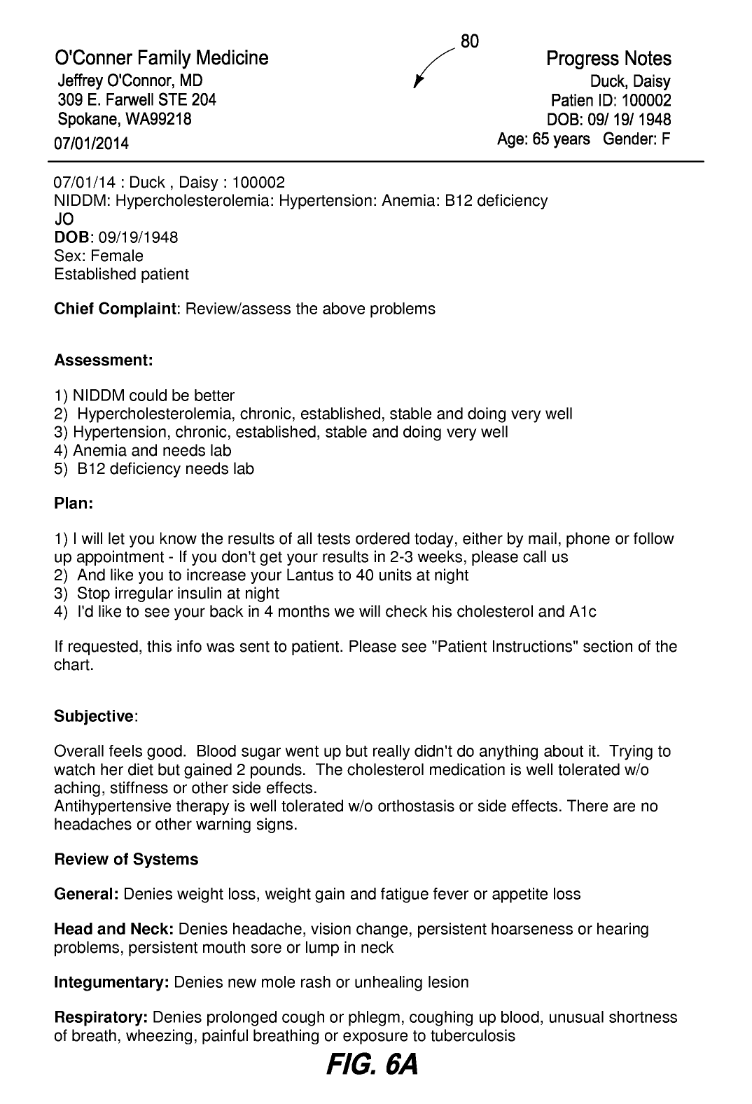

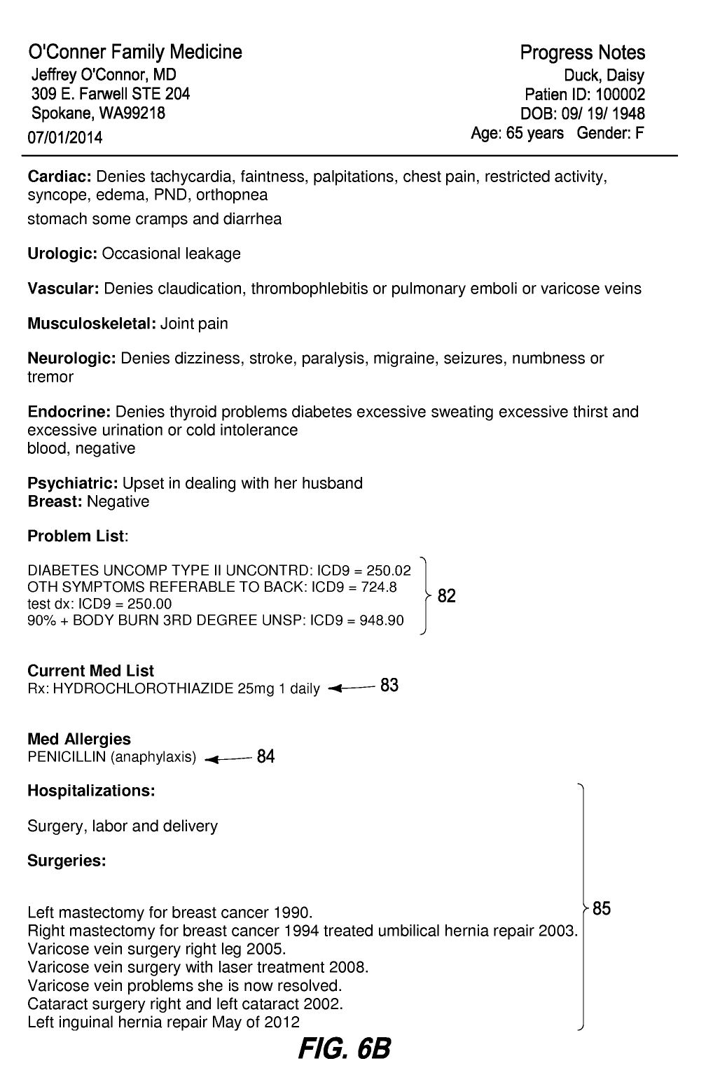

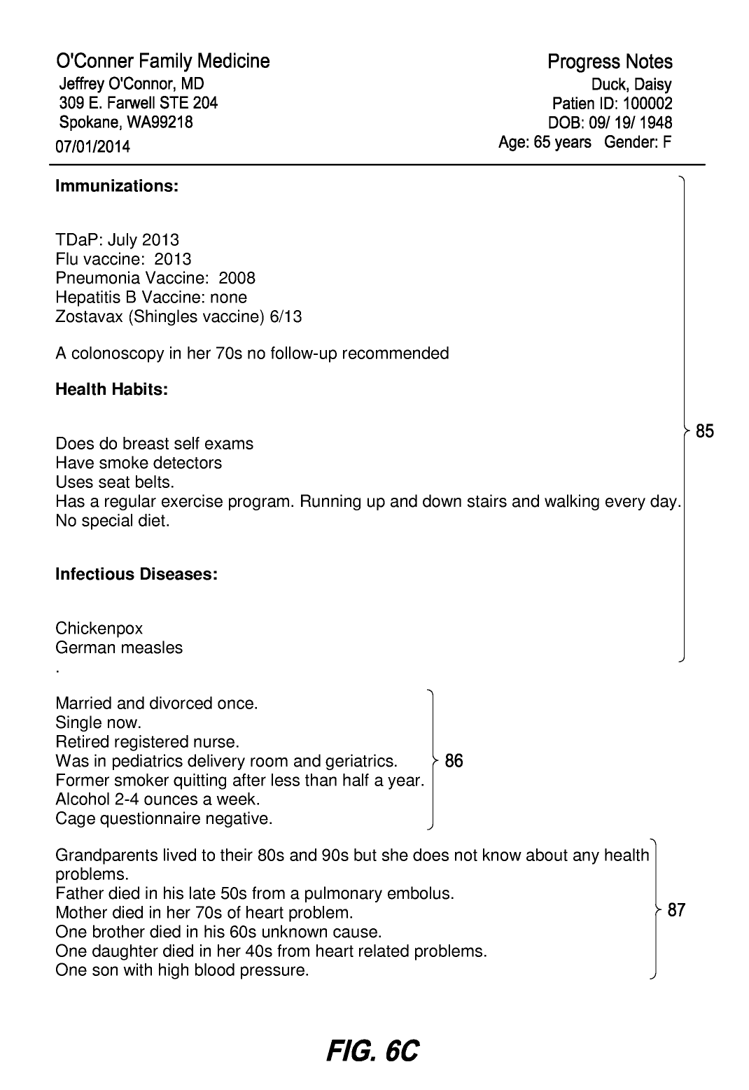

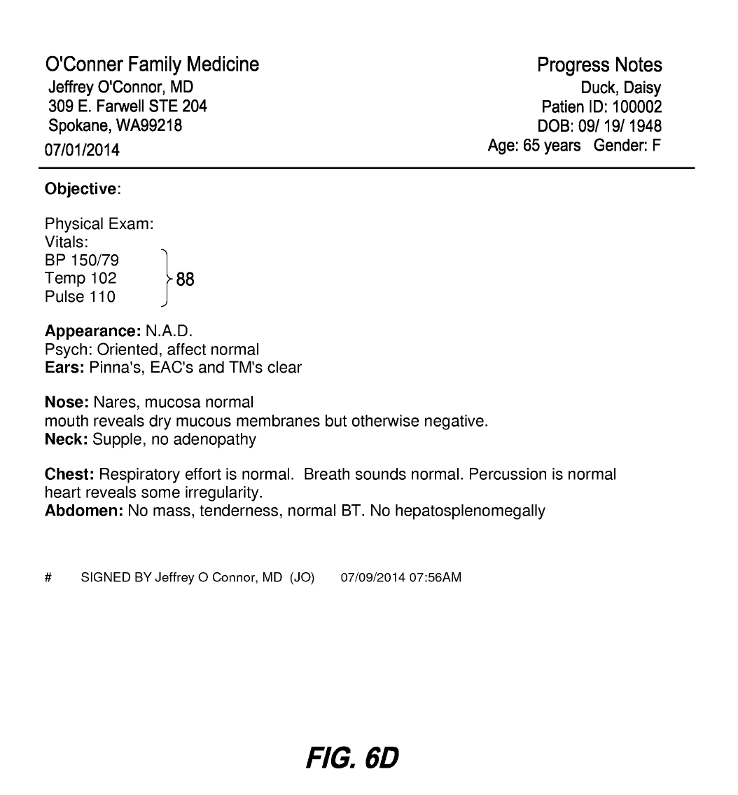

Referring to FIGS. 6A-D, an example of a standard office note document 80 in the form of a progress note which is stored in the patient's chart of the electronic health record application 18 is shown according to one embodiment. The example document 80 is generated from the expanded text of note 40 as well as other data regarding the patient, for example retrieved from the patient database and patient chart.

For example, the data of section 82 has been retrieved from the chart of the patient in the electronic health record application 18 as a result of an .IMP code in the depicted example. The data of section 83 has been retrieved from the chart of the patient in the electronic health record application 18 as a result of an .ICM code in the expanded text of note 40 in the depicted example. The data of section 84 has been retrieved from the chart of the patient in the electronic health record application 18 as a result of an .IAL code in the expanded text of note 40 in the depicted example. The data of section 85 has been retrieved from the chart of the patient in the electronic health record application 18 as a result of an .IPH code in the expanded text of note 40 in the depicted example. The data of section 86 has been retrieved from the chart of the patient in the electronic health record application 18 as a result of an .ISH code in the expanded text of note 40 in the depicted example. The data of section 87 has been retrieved from the chart of the patient in the electronic health record application 18 as a result of an .IFH code in the expanded text of note 40 in the depicted example. The data of section 88 has been retrieved from the chart of the patient in the electronic health record application 18 as a result of .IV1, .IV2 and .IV3 codes in the expanded text of note 40 in the depicted example.

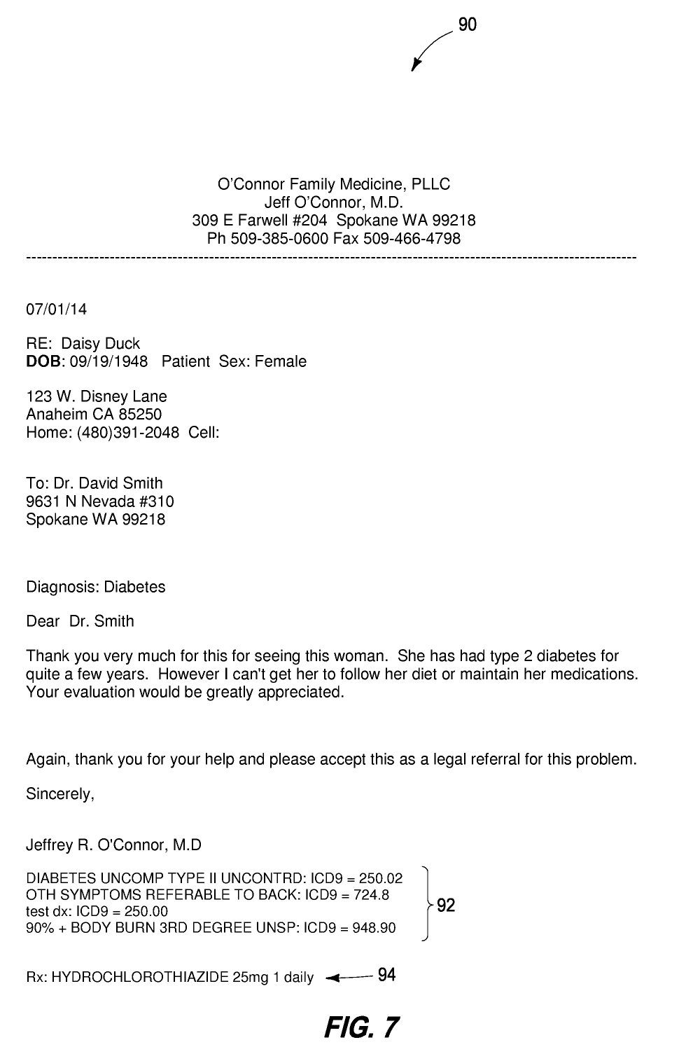

Referring to FIG. 7, an example of a referral letter document 90 is shown according to one embodiment. The example document 80 is generated from the expanded text of referral letter 60 as well as other data regarding the patient. For example, the data of section 92 has been retrieved from the chart of the patient in the electronic health record application 18 as a result of an .IMP code in the expanded text of referral letter 60 in the depicted example. The data of section 94 has been retrieved from the chart of the patient in the electronic health record application 18 as a result of an .ICM code in the expanded text of referral letter 60 of FIG. 4 in the depicted example.

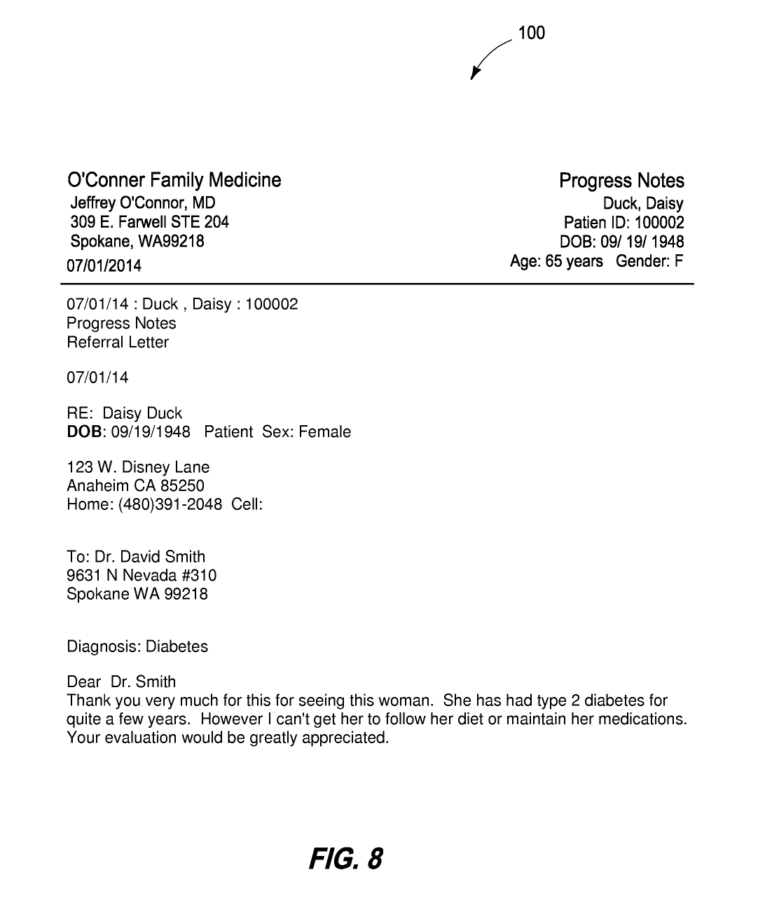

Referring to FIG. 8, an example of the referral letter reformatted to a progress note document 100 for placement in the patient's chart of the electronic health record application 18 is shown. The progress note 100 was generated as a result of the “make a progress note” keyword in the transcribed textual content. Data of the referral letter which is stored elsewhere in the chart of the patient may be deleted from the progress note 100 (e.g., medical problems, medications, etc.).

Referring to FIG. 9, an example of a patient instructions document 110 which is sent to the patient and stored in the “patient instructions” of the patient's chart of the electronic health record application 18 is shown. The instructions 110 were generated as a result of the .K code of the expanded text of note 40 of FIGS. 3A-3C which was generated as a result of the “#2” action keyword of the transcribed textual content of Table A.

A summary of a document generation method is described below according one embodiment. Other embodiments including more, less and/or alternative steps are possible.

Initially, a file comprising a transcription of dictated content is accessed. A patient database is accessed to retrieve appropriate information for the subject patent being treated using a patient identifier located in the dictation. Headers are created for each document for the subject patient using the retrieved information. Thereafter, the transcription may be manually reviewed and corrected if needed.

The transcription is searched for structure keywords which define the types of documents to be generated and the appropriate spacing, formatting and default content for each document. The documents are created and initially available for manual review for correct patient information and content relationship (i.e., verify that the content of the transcription has been associated with the correct patient).

Thereafter, a separate file is generated for each header and there may be multiple files for each patient in one embodiment. In one embodiment, “.D:” is an action keyword and the output file is split into separate files (one for each header) based upon occurrences of this keyword. Each file contains only the text from one “.D” keyword to the “.D:” keyword of the next header encountered. If there are 30 headers in the original file, there will be 30 separate files created which permits each document to be processed as a separate file and each document is processed completely (e.g., reiteratively) before the next file is started in one embodiment. This step assists with accurate expansion of the text content as intended by the user since the user can dictate several different documents for any given individual (i.e. a phone call note, progress note, referral letter), in any sequence or in totally separate sections of the original text file. Furthermore, the user need not be concerned that the process will expand the wrong keyword in the wrong area for a given patient or incorrectly identify who the patient is. Therefore, in one embodiment, each file has its own context resulting in a multiplicity of document types and sequences. Each file may be checked for grammatical and spelling errors.

As discussed above, content keywords are expanded to produce blocks of standardized text containing information the user wishes to be included in the document. The resulting blocks of text can also contain additional keywords that, depending on the context, can result in further text expansion (i.e., recursive) or other operations or actions. The rules for text expansion or processing may be different for different documents, or different portions of the same document.

For instance, in one particular document or section of a document, the phrase “chemistry panel” may not be expanded at all according to the rules. In another document or other document section, the rules may cause text expansion to occur where a similar phrase—normal chemistry panel—may be expanded to say “your chemistry panel is normal”. Depending on the document and applicable rules, the two words “chemistry panel” may result in further expansion and inclusion of “(that is the test for diabetes liver and kidney function)”. The resulting text would state “your chemistry panel (that is the test for diabetes liver and kidney function) came back normal” in this example.

The data source for the content keywords can be contained within the coding itself or a database stored within the storage circuitry. Simple phrases as noted above, or even large blocks of text that remain relatively static over time, can easily be stored within the coding itself in one embodiment. However, maintaining content in an external data source allows the user to easily manipulate the content that is to be included in the final document. Furthermore, it is usually more straightforward to locate a content keyword within a database and alter how it is expanded as opposed to being implemented within the code itself.

As mentioned previously, the text expansion may result in the generation of new keywords which may need to be expanded. Accordingly, the textual content of a document is searched following text expansion for the presence of additional keywords. The additional keywords may cause different actions to be performed such as further expansion of text, or generation of a new document. The textual content is searched and the actions performed recursively until no new keywords are found in one embodiment. Furthermore, the sequence of expansion may be different for different documents as defined by rules which control the generation of the respective documents.

In one embodiment, for medication names occurring with the textual content (e.g., in the “plan” section of a note), both the trade and generic name can be retrieved, regardless which is given by the user, creating a clearer description of the medication being referenced thereby increasing patient safety.

In one embodiment, documents are generated to assist with activities which are important to a given application of use. For example, medical billing is a complicated process that depends on correct formatting and presentation of data along with specific codes for proper reimbursement. In one embodiment, ICD codes which describe patient diagnosis, may be inserted and formatted for final presentation. In one embodiment, the method reduces a medical diagnosis to a code by converting textual content including medical English into a correct ICD code with proper formatting automatically and without further input from the user.

Thereafter, the user may review the generated final documents and make any corrections, for example using a word processor application. The files may be maintained in separate files or combined into a final text file (e.g., *.txt) the files may be used to print documents for mailing and paper charts as well as storage within the electronic health record of the subject patient.

Although the above-described embodiments pertain to document generation following a patient encounter, the methods and systems may be used to generate forms for use prior to a patient visit. For example, patient information may be retrieved from a simple patient identifier and keywords may be used to define the particular forms to be generated.

As described above, at least some aspects of the disclosure are directed towards document generation methods and systems which reduce a number of words inputted (e.g., dictated, typed, etc.) into an initial text file and allow free flow of dictation without the user needing to stop at each new document. These aspects reduce the work load of the user while ultimately producing a multiplicity of completed document(s), document subjects and document types, all exactly representing the intent of the user.

Some example embodiments described herein are implemented as software processes that permit the user to use simple keywords and syntax to dictate a reduced number of words into a text document compared with dictating an entire document. Some of the example embodiments described above automatically define a structure of the document, automatically add new textual content to the document, automatically retrieve information from a database, and/or automatically generate new documents without the user directing the actions. Keywords are used in one embodiment to automatically cause the actions to be performed and finished documents of multiple types to be generated including default textual content and dictated content specific to patients being treated with minimal further input from the user.

According to one embodiment, multiple document types may be generated based on syntax alone. Continuous or intermittent dictation of minimized text into one file is provided in one embodiment with syntax determining start, identification of, subject of and type of new documents. At least one embodiment uses standardized, common and simple keywords to initiate and direct content development within each document being generated. In one embodiment, content of documents generated in one embodiment is directed by the user who can use keywords that may be expanded into the desired content, while also permitting dictation of sections of the text content that may be more unique or custom for a given patient or other subject. In addition, keywords and content development can be customized for each user based upon their needs in an example embodiment.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended aspects appropriately interpreted in accordance with the doctrine of equivalents.

Further, aspects herein have been presented for guidance in construction and/or operation of illustrative embodiments of the disclosure. Applicant(s) hereof consider these described illustrative embodiments to also include, disclose and describe further inventive aspects in addition to those explicitly disclosed. For example, the additional inventive aspects may include less, more and/or alternative features than those described in the illustrative embodiments. In more specific examples, Applicants consider the disclosure to include, disclose and describe methods which include less, more and/or alternative steps than those methods explicitly disclosed as well as apparatus which includes less, more and/or alternative structure than the explicitly disclosed structure.

What is claimed is:

1. A document generation method comprising:
accessing a file comprising a transcription of dictated content;
searching the dictated content;
during the searching, locating an agent identifier in the dictated content which identifies one of a plurality of agents;
as a result of the locating the agent identifier, generating a first document regarding the one agent which comprises the dictated content;
during the searching, locating one of a plurality of structure keywords in the dictated content;
formatting the first document in accordance with the one structure keyword;
during the searching, locating one of a plurality of content keywords in the dictated content;
adding additional textual content to the first document in accordance with the one content keyword;
locating one of a plurality of action keywords in the first document; and
generating a second document regarding the one agent in accordance with the one action keyword.

2. The method of claim 1 wherein the locating the agent identifier terminates generation of a previous document and initiates the generating the first document.

3. The method of claim 1 further comprising identifying a plurality of headers, and creating a plurality of files corresponding to the headers.

4. The method of claim 1 further comprising locating another of the action keywords in the dictated content, and the generating the first document comprises generating the first document comprising one of a plurality of types of documents which corresponds to the one action keyword.

5. The method of claim 1 wherein the one action keyword was added as the additional textual content during the adding.

6. The method of claim 1 further comprising locating a plurality of occurrences of a protected keyword in the first document, and performing an action only as a result of the location of the first occurrence of the protected keyword.

7. The method of claim 1 further comprising:
locating a plurality of occurrences of a protected keyword in the first document;
first changing the protected keywords to other words; and
second changing the other words back to the protected keywords after the first changing.

8. The method of claim 1 wherein the locating the one action keywords comprises locating the one action keyword within the dictated content.

9. The method of claim 1 wherein the additional content includes a code configured to cause the insertion of the second document into an electronic health record of the agent.

10. The method of claim 1 wherein the first document is a note inserted into an electronic health record of the agent, and the second document is a letter to the agent.

11. The method of claim 1 wherein the generatings of the first and second documents comprise generatings using an electronic health record application.

12. The method of claim 1 wherein the adding the additional content comprises adding a default list of a plurality of default items to the first document and default information associated with one of the default items and dictated content associated with another of the default items.

13. The method of claim 12 wherein the default information is associated with the one default item as a result of the dictated content not including content regarding the one default item and the dictated content is associated with the another default item as a result of the dictated content including content regarding the another default item.

14. A document generation method comprising:
accessing a file comprising a transcription of dictated content;
first locating an agent identifier in the dictated content which identifies one of a plurality of agents;
as a result of the first locating, generating a document regarding the one agent which comprises the dictated content;
second locating a first keyword in the dictated content of the document;
as a result of the second locating, adding additional textual content which includes a second keyword to the document;
after the adding, third locating the second keyword in the document; and
as a result of the third locating, performing an action with respect to the document.

15. The method of claim 14 wherein the performing the action comprises adding further additional textual content to the document in accordance with the second keyword.

16. The method of claim 14 wherein the performing the action comprises generating another document.

17. The method of claim 14 wherein the performing the action comprises accessing content from an electronic health record application.

18. The method of claim 14 wherein the performing the action comprises accessing content from an external data source.

19. The method of claim 14 wherein the third locating comprises locating the second keyword in the additional textual content.

20. A document generation method comprising:
accessing a file comprising a transcription of dictated content;
locating an agent identifier in the dictated content which identifies one of a plurality of agents;
as a result of the locating the agent identifier, generating a document regarding the one agent which comprises the dictated content;
locating first and second occurrences of a word in the dictated content of the document; and
performing an action with respect to the dictated content only as a result of the locating of the first occurrence of the word and not performing the action as a result of the locating of the second occurrence of the word.

21. The method of claim 20 wherein the performing the action comprises generating additional content which includes the second occurrence of the word.

22. The method of claim 21 wherein the performing the action comprises adding a section within the document.

23. The method of claim 22 wherein the section comprises a portion of the dictated content.

24. The method of claim 21 wherein the performing the action comprises revising a structure of the document.

25. The method of claim 20 wherein the performing the action comprises performing a first action of converting the first occurrence of the word into a keyword, and further comprising locating the keyword in the document, and performing a second action with respect to the document as a result of the locating the keyword.
